(19) United States
(12) Patent Application Publication
(10) Pub. No.: US 2008/0319655 A1
(43) Pub. Date: Dec. 25, 2008

(54) Method for Generating an Enhanced Map

(75) Inventor: Linde Vande Velde, Merelbeke (BE)

Correspondence Address: FLIESLER MEYER LLP, 650 CALIFORNIA STREET, 14TH FLOOR, SAN FRANCISCO, CA, 94108, US

(73) Assignee: TELE ATLAS NORTH AMERICA, INC., Redwood City, CA (US)

(21) Appl. No.: 12/090,476

(22) PCT Filed: Oct. 17, 2005
(86) PCT No.: PCT/EP2005/055317

§ 371 Date: Aug. 20, 2008

(51) Int. Cl. G01C 21/30

(52) U.S. Cl. 701/208

(57) ABSTRACT

The invention relates to a method for generating 3D objects within a digital map. The method comprises the actions of: —retrieving at least one image sequence, each image having corresponding location coordinates; —retrieving a set of data of an object from an electronic map, the set of data including location coordinates; —selecting from the at least one image sequence at least one image including a representation of the object by means of the location coordinates of the image sequences and the location coordinates in the set of data; —determining from the selected images at least one characteristic of the object; —adding the at least one characteristic of the object to the set of data; —storing the set of data and the at least one characteristic in said enhanced map.

### FIELD OF THE INVENTION

The present invention relates to a method for generating an enhanced map. The invention further relates to a processor readable storage medium storing an enhanced map, an apparatus including a processor readable storage medium storing an enhanced map and an apparatus for reproducing a set of data stored in an enhanced map. The invention further relates to a processor readable storage medium storing an enhanced map.

### PRIOR ART

Next to the growing car-navigation market, the market of Location Based Services (LBS) applications is growing very fast. It is expected that this application area in the near future will develop into a mass market. The currently available digital maps are the source for both expanding markets.

Location Based Services (LBS) are up and running and successful in the market. Digital maps are an important component for these services. Current available digital maps are based on requirements from car navigation with relatively little attention for map display. Apart from some basic areas like woods and water only the line work of the road network is displayed.

However, pedestrians represent next to car drivers an important user group of LBS. This has implications for the map, especially for map display. Using an in-car navigation system, a car driver gets his GPS position improved with inertial information, so there is no doubt of his position and no doubt of the direction he is looking and heading. GPS is an abbreviation of Global Positioning System. Navigation systems for pedestrians using LBS are different. These get their position from GPS only. As a result the pedestrians generally do not know in which direction they are looking.

This shortcoming can be solved by improving orientation possibilities by enhancing the standard digital road maps with features such as road areas, sidewalk areas and 3D representations of the buildings.

Besides aiding the pedestrian in orientation, such enhanced map display features can aid the driver in a car such that on crucial decision points during his journey, the driver will recognise the building in one glimpse. In general, it is well appreciated that reasonably realistic 3D representations of the surroundings can aid in orientations for many map applications and is generally appealing to the user of the map.

In order to enhance the digital maps with high end three dimensional (3D) Models, map surveyors need to collect all the required information in the field. In literature 3D-models are sometimes called Building Models or City Models. Map surveyors need to take ground level pictures and make extra geometrical measurements with typical surveyor devices. The ground level pictures and geometrical measurements are processed with typical 3D tools, such as 3D Studio Max. The results are 3D City Models in VRML, 3DS formats. VRML is an abbreviation of Virtual Reality Modelling Language, which is a specification for displaying three dimensional objects on the World Wide Web. 3DS is the file extension of files with objects in the 3D Studio mesh object file format. The information of those 3D objects is stored such that they can only be visualised in one level of detail. The level of detail corresponds to the detail in which the information of the object was converted to be stored.

Collecting those pictures and geometrical measurements on the spot is time consuming and contains the risk that if during production process some data turns out to be missing, one has to go back to the spot to collect extra information.

Terrestrial and Aerial Laser scan technology is an emerging technology allowing to produce high end 3D City Models. However, the total cost to generate those high end 3D City Models is very high.

Therefore, nowadays High end 3D City Models are in general very expensive. The costs will vary with the level of detail achieved. The level of detail of the 3D representations of the buildings on a display of e.g. a navigation system in a car or for a pedestrian has to be such that on crucial decision points during his journey, the user will recognise the building in one glimpse.

3D representations of buildings can be made with varying levels of detail. Examples of these varying levels are described in “Navigate by Maps for Multi-Modal Transport”, by Vande Velde, Linde, Intelligent Transportation Systems (ITS) Madrid 2003. The first level of detail is a so called generic block model, rather a nice technical result than something which appeals to many users. In order to arrive at a quasi realistic representation of the city, specific roof and front texture are assigned to the blocks.

For each required level of detail there are different sources which can be used to generate building information in a semi-automatically way. For example, pictures from satellites and airplanes can be used. Furthermore, the amount of additional information to be added to a city map to enable 3D representation depends on the level of detail.

In November 2004 is published in the proceedings of ITS Nagoya, JP the paper with the title “Navigation in 3D, Enhanced map display for car navigation and LBS”. Said paper describes in general terms how the raw material for the Enhanced map is obtained and how the extracted information could be stored in the database.

Furthermore, is a paper published in the proceedings of next generation 3D City Models, Bonn, Germany 21-22 Jun. 2005 with the title “Tele Atlas 3D navigable maps”. This paper addresses the same general subject matter as the first paper. However, the second paper discloses is some more detail the modeling of facades with typical windows. Furthermore, is additionally disclosed a clean up process for facades to remove trees, cars.

3D map display will not only enrich the functionalities of navigation systems but also opens a complete new world for the development of various 3D Geographic Information System (GIS) and navigation applications. The key is generating minimally realistic 3D information in a cost effective way.

### SUMMARY OF THE INVENTION

The present invention seeks to provide an improved method to generate 3D objects within digital maps.

According to the present invention, the method comprises:

retrieving at least one image sequence, each image having corresponding location coordinates;

retrieving a set of data of an object from an electronic map, the set of data including location coordinates;

selecting from the at least one image sequence at least one image including a representation of the object by means of the location coordinates of the image sequences and the location coordinates in the set of data;

determining from the selected images at least one characteristic of the object;

adding the at least one characteristic of the object to the set of data;

storing the set of data and the at least one characteristic in said enhanced map.

The invention is based on the recognition that a lot of the material needed to generate a 3D enhanced map is already available. Mobile mapping vehicles are used to collect data for enhancement of 2D city maps. For example, the location of traffic signs, route signs, traffic lights, street signs showing the name of the street etc.

The mobile mapping vehicles have a number of cameras, some of them stereographic and all of them are accurately geo-positioned as a result of having precision GPS and other position determination equipment onboard. While driving the road network, image sequences are being captured. The cameras are positioned in such a way that even the information needed for the production of 3D building objects is present and can be used as source information for 3D City Maps.

As the mobile mapping vehicles records more then one image sequence of an object, e.g. a building, and for each image of a sequence the geo-position is accurately determined. Image sequences with geo-position information will be referred to as geo-coded image sequences. The geo-coded image sequences could be used to determine a characteristic of a building. The height of a building or a facade of a building are examples of characteristics. The location of a building for which for example the height has to be determined is taken from the existing 2D city map. This could be done by taking the footprint of said building from the 2D city map. A footprint could be obtained by interpretation of aerial imagery for example. For said building, one or more images showing said building are selected. For each of said pictures the location and direction of the camera while taking said picture is known. By means of the footprint and the location and the direction of the camera, the position of a façade of said building can be determined in said pictures. By knowing the position of the façade in the images, the lower location of the ground floor of the façade and the upper location of the transition of the façade and the roof can be determined. The upper location and the lower location in the images, as well as the height of a building can be calculated.

In a further embodiment of the invention, said selecting action includes

selecting from the at least one image sequence at least two images, each of the at least two images including a representation of the object by means of the location coordinates of the image sequences and the location coordinates in the set of data; and a characteristic of the object is the height of the object.

Said feature enables to use triangulation to determine the height of a building accurately by means of the selected images.

In a further embodiment of the invention, the at least one image sequence includes a stereo scopic image sequence and said action of selecting includes selecting a stereo scopic image pair so as to obtain the at least two images. An advantage of using a stereo scopic pair of images is the accurate position of the recording element of the images with respect to each other. This enables an accurate determination of distances in stereo scopic images.

In a further embodiment of the invention the set of data comprises location information of a façade, wherein the determining action of the method includes

determining in the images the location of the ground floor of said façade corresponding to the object;

determining in the images the location of the transition of said façade and the roof corresponding to the object;

calculating the height of the object by means of the location of the ground floor and the location of the transition.

Using said actions, allows determining accurately the height of a façade by means of image processing. The location of the ground floor of the façade in the image can be determined by means of the geo-coded information in the 2D-city map and the geo-coded information of the images and the orientation of the camera. Geo-coded information is the information which identifies the absolute or relative location coordinates of an object in a map and which is obtained from geo-position information. Image processing can be used to determine the transition of said façade and the roof of the object.

In a further embodiment of the invention, the method further comprises selecting from the at least one image sequence an image by means of the location coordinates of the image sequences and the location coordinates in the set of data, in which said image includes a representation of the object;

transforming the selected image into a frontal view image of a façade of the object by means of the location information;

generating a cutout corresponding to a frontal view of the façade of said object by means of the location coordinates and the height;

converting the cutout in a representation of the cutout;

storing the representation of the cutout in said enhanced map.

These actions allow generating efficiently frontal view images of the façades. First a frontal view is generated by stretching the angled view of the image comprising the façade. Subsequently, the coordinates in the 2D map and the height are used to generate the cutout of the façade. Storing only front views of façade enables to reproduce efficiently three dimensional views of a building.

In a further embodiment of the invention, said storing includes:

generating Meta data for said representation of the cutout, the Meta data including location coordinates corresponding to the location coordinates in the set of data;

combining the representation of the cutout and the Meta data;

storing the combination in a library of said enhanced map.

Using this embodiment enables to generate one enhanced map that could be easily converted to a less enhanced map. By having the details of the façades stored in a dedicated library, said library can be easily removed from the enhanced map, so as to generate a less enhanced map with only height information, which could be used for 3D representation of buildings in the generic block model.

In a further embodiment of the invention, said converting action includes:

determining the number of floors in the cutout;

storing the number of floors in said enhanced map.

Using this embodiment enables to generate more efficiently façades. For example, if each floor or floor could be represented with the same façade. This reduces the amount of storage space in the library.

In a further embodiment of the invention, said converting action includes:

splitting up the cutout in components;

comparing the components with façade components stored in a component library;

replacing components with similar façade components in the component library by corresponding references to said similar façade components.

Using this embodiment enables to generate more efficiently façades. By replacing parts of the images of a façade by a reference to a corresponding image part already stored in a component library, the amount of storage space in the enhanced map to enable the enhancement can be reduced.

In a further embodiment of the invention, the enhanced map is dedicated for a predefined application, the set of data includes a footprint of a building, a footprint includes elements each representing a façade, each element include location coordinates, wherein execution of the storing action for an element is performed in dependence on the predefined application.

Using this embodiment enables to store only details in the enhanced map which could be used by the targeted application. This results in removal of unnecessary details and the generation of an enhanced map with minimal storage space.

Another embodiment of a method to provide an improved method to generate 3D maps comprises:

retrieving at least one image sequence, each image having corresponding location coordinates;

retrieving a set of data of an object from an electronic map, the set of data including location coordinates of a façade of said object and an object height;

selecting from the at least one image sequence an image by means of the location coordinates of the image sequences and the location coordinates in the set of data, in which said image includes a representation of the object;

transforming the selected image into a frontal view image of a façade of the object by means of the location information;

generating a cutout corresponding to a frontal view of the façade of said object by means of the location coordinates and the height;

converting the cutout to a representation of the cutout;

storing the representation of the cutout in said enhanced map.

Similarly, with this method electronic maps can be enhanced with information that can be deduced from already available mobile image sequences. First, an available angle view image is transformed to frontal view image of a façade. From the frontal view image the front view of the façade is cut out.

Another improved method for generating an enhanced map comprises:

retrieving a set of data of an object from an electronic map, the set of data including location coordinates of a façade of said object and an object height;

retrieving a representation corresponding to a frontal view image of said façade,

generating Meta data for said representation, the Meta data including location coordinates corresponding to the location coordinates in the set of data;

combining the representation and the Meta data;

storing the combination in a library of said enhanced map.

This embodiment of the invention enables to find easily and uniquely a façade corresponding to a boundary of a footprint. Furthermore by using equivalent location coordinates for both a boundary and a corresponding façade, a 3D reproducing device will place the façade exactly above the boundary of the footprint from the 2D city map when generating a 3D view.

A further aspect of the invention relates to A processor readable storage medium storing an enhance map, said enhanced map having characteristics of an object added to said map. In a exemplary embodiment of the processor readable storage medium the enhanced map includes a representation of façade, wherein the representation of the façade has been obtained by transforming a perspective view image of said façade into a frontal view image of said façade.

The present invention can be implemented using software, hardware, or a combination of software and hardware. When all or portions of the present invention are implemented in software, that software can reside on a processor readable storage medium. Examples of appropriate processor readable storage medium include a floppy disk, hard disk, CD ROM, memory IC, etc. When the system includes hardware, the hardware may include an output device (e.g. a monitor, speaker or printer), an input device (e.g. a keyboard, pointing device and/or a microphone), and a processor in communication with the output device and processor readable storage medium in communication with the processor. The processor readable storage medium stores code capable of programming the processor to perform the actions to implement the present invention. The process of the present invention can also be implemented on a server that can be accessed over the telephone lines.

Some of the actions of operation described below are found in prior art enhanced map generators. However, the prior art enhanced map generators do not use geo-coded image sequences to obtain the information to enhance a map as described below.

### SHORT DESCRIPTION OF DRAWINGS

The present invention will be discussed in more detail below, using a number of exemplary embodiments, with reference to the attached drawings, in which

FIG. 1 is a simplified block diagram of an enhanced map generator.

FIG. 2 is a flowchart describing an exemplar method for generating an enhanced map.

FIG. 3 is a flowchart describing an exemplar method for generating a representation of a façade to enhance an enhanced map further.

FIG. 4 is a block diagram of an exemplar hardware system for implementing an enhanced map generator and/or reproducing apparatus.

### DETAILED DESCRIPTION OF EXEMPLARY EMBODIMENTS

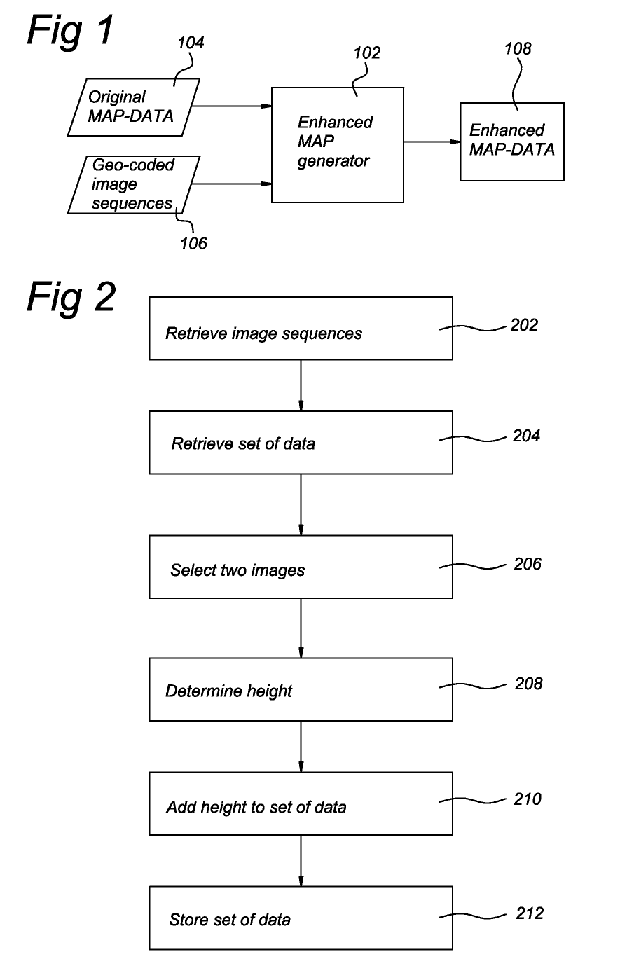

FIG. 1 is a simplified block diagram of an enhanced map generator. FIG. 1 shows an enhanced map generator receiving inputs and providing an output. The inputs include original map data 104 and geo-coded image sequences 106. The output is enhanced map data 108, enhanced with at least height information of buildings. The original map data 104 is a collection of one or more files making up a map database. The original map data 104 includes geo-coded digital 2D city maps, including building footprints information and corresponding geo-position information. The geo-position information in geo-coded digital 2D city maps corresponds to the location coordinates of objects, such as XY coordinates or the like. The geo-coded image sequences 106 are image sequences obtained with a mobile mapping vehicle or the like. The mobile mapping vehicle, e.g. a delivery van or multi purpose vehicle, has a cluster of image sensors mounted externally. The image sensors could be in the form of cameras such as CCD cameras. At least one pair of the image sensors is stereo-scopic pair. Precise position and orientation of the vehicle are obtained from GPS and an inertial system. The image sensors provide a number of overlapping images of all features of interest in the vicinity of the vehicle. These images are stored for later processing. Furthermore, the position of the image sensors with respect to each other is accurately determined and the orientation of the image sensors with respect to the vehicle. This information is digitally stored as camera calibration information in a file. The global positioning system determines accurately the geo-position of the vehicle. In combination with the camera calibration information, the geo-position of the image sensors is determined. A processor, e.g. a personal computer, combines geo-positions with the image sequences, to enable the determination of the exact geo-positions of each of the images. While driving the road network, the image sequences are being captured and the corresponding geo-coded information is added. Reference is made to “Mobile Mapping by a Car-Driven Survey System (CDSS)”, by Wilhelm Benning, Thomas Aussems, Oct. 29, 2000, Geodatisches Institut der RWTH Aachen 1998, which discloses in more detail a mobile mapping vehicle and its functioning.

The received original map data and geo-coded image sequences are stored on a processor readable storage medium. The enhanced map generator receives the original map data 104 and the geo-coded image sequences and retrieves building height information from the image sequences. The height information is combined with the original data, so as to obtain the enhanced map data. The enhanced map data enables a reproducing apparatus, such as a navigation system, to produce a 3D representation of map data.

FIG. 2 is a flowchart describing an exemplar method for generating an enhanced map. In action 202 at least one of the geo-coded image sequences is retrieved and stored in a computer readable memory. In action 204 a set of data of an object, such as a building, is retrieved from a 2D city map. The set of data includes a building footprint and geo-coded information for said footprint. A footprint is the outline of a building at ground level. Normally the outer walls of façades of a building make up a footprint of a building.

In action 206 two images which include a view of the building corresponding to the set of data are selected from the geo-coded image sequences. This could be done as the position of the camera at the moment of recording the images is known and the direction of the camera is known as is its viewing angle. With this information, it can be determined whether an image includes a view of a selected building. In an exemplar embodiment of the method the two images are obtained by a stereo scopic camera.

In action 208 the height of the building is determined with triangulation, which is a well known method of determining the position of a fixed point from the angles to it from two fixed points a known distance apart. This can be done as the distance between the locations of the camera is known and stored as part of the calibration. With triangulation the building corresponding to the set of data can be identified in the image. By means of well known image processing techniques the lower side and the upper side of the outer wall of a building can be identified and the corresponding geo-positions. The geo-position of a lower side of an outer wall and the geo-position of an boundary of said building could be compared to determine based on some matching criteria that these represent the same object. If the geo-position of a lower side matches the geo-position of a boundary, the height of the building can be determined with the position of the upper side and the lower side of an outside wall in the image and the geo-positions of the images and if necessary the camera calibration information comprising characteristics of the orientation of the camera with respect to the vehicle. It should be noted that the height is defined to be the distance between the ground floor of a façade and the transition between said façade and the roof of the building. Furthermore, only one height is added to a footprint. Therefore, the most representative façade is determined to define the height of a building. To enhance further the map, to each footprint a parameter is added to indicate the roof type of a building.

It should be noted that the height of a façade could be determined by means of only one geo-coded image. Via the geo-position of the vehicle the known position of the cameras with respect to the vehicle, its orientation and its baseline and spacing and lens calibration and the geo-position information of a façade in a map, an object such as a building can be picked up from one image. However, the result can only be accurate of all the geo-positions of the object in the map and the geo-position together with the calibration information of the camera is very accurate. With one image it is not possible to determine the geo-positions of an object in said image. Consequently, no check on similar geo-positions can be performed.

In action 210 the calculated height of the building is added to the set of data. Finally, in action 212, the set of data is stored in the enhanced map. This enhanced map enables a navigation system to generate a block level representation of buildings. All the outside walls have the same height. If a roof type is added to the set of data, the roof is placed upon the block generated by means of the footprint and the height.

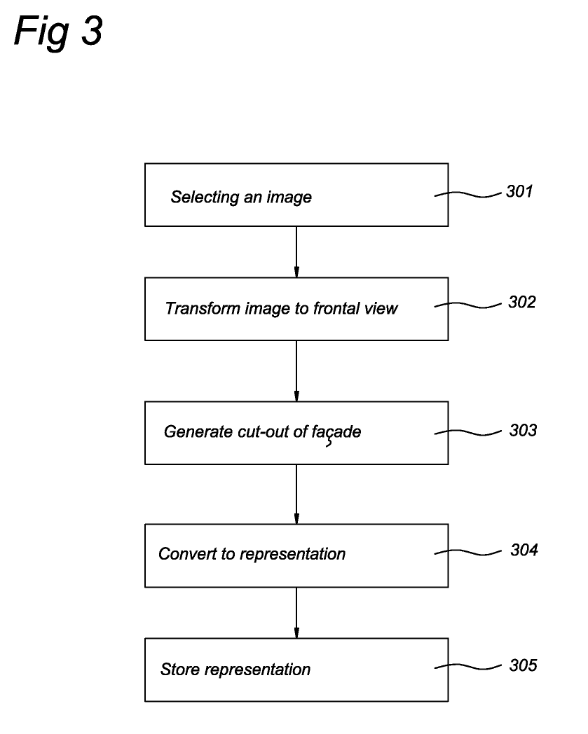

FIG. 3 is a flowchart describing an exemplar method for generating a representation of a façade to enhance an enhanced map further. The method disclosed above, enables to generate a block level representation of buildings. The 3D representation could be further enhanced with details of the façades. For each boundary of a footprint a detailed façade could be generated. However, in order to limit storage space it is suitable to generate detailed façades only for façades corresponding to boundaries of footprints visible from the road.

In action 301, from one of the image sequences an image including a façade for a boundary of the footprint is selected. As the image sequences are obtained with a mobile mapping vehicle, the images include an angled view of façades and not a frontal view. The image is selected by means of the geo-coded information and the camera calibration information of the image sequences in combination with the geo-positions of the boundary for which a detailed façade has to be generated. With said location information the angle of view of the façade in the image can be determined. Furthermore, with said location information and the height of the façade, the area of the façade in the image can be easily determined. As the position of the camera at the instant of taking the image is known and the position of the boundary of the footprint is known, the distance between the pixels of the area of the façade and the camera is known. The linear relationship between the position of a pixel in an image and the assumed distance between the pixel and the camera is used to transform the angled view image of the façade into a frontal view image. This transformation corresponds to stretching the area of the pixels such that the areas have a virtual equal distance to the camera. The transformation is performed in action 302. Subsequently, in action 303 the rectangle formed by the outline corresponding to the boundary of the footprint and the height of the object is cutout of the image.

In action 304 the cutout is converted in a representation of the cutout. The whole cutout could be transformed in to a picture according to a standard such as JPEG, GIF, and TIFF. In action 305, the representation of the cutout is stored in the enhanced map.

The representation could be stored together with the footprint in the same database. In an exemplary embodiment of the enhanced map the 2D city map including the footprint and height of buildings is stored separately from a façade library. To enable to find a façade corresponding to a boundary of the footprint, Meta data is added to a façade. Meta data can describes how and when and by whom a particular set of data was collected, and how the data is formatted. Meta data is essential for understanding information stored. In an exemplary embodiment the Meta data includes geo-positions corresponding to the geo-positions of the corresponding boundary. This has the advantage that the size of a picture of the façade will match with the size of the boundary. This results in the placement of the façade precisely on the boundary in a perspective 3D view. Furthermore, this embodiment enables a unique and simple relationship between objects in the 2D city map and the façade library.

An enhanced map with separately a 2D city map and a façade library, enables to generate in one cycle an enhanced map that could be used for high-end applications with representation of buildings in three dimensional view with high details, and that could be easily adapted to be used in low-end applications with for example only block level representation. By just removing the façade library from the enhanced map, the enhanced map for low-end applications is obtained.

Action 304 could further comprise the action of determining the number of floors of the façade in the cutout. This could be done with standard image processing techniques. The number of floors is used to split up the cutout into components. For each floor a component is generated. A component could include a picture or a reference to a picture. The use of a reference to a picture enables to reduce the storage capacity for the façade library. For example, a façade of a block a flats includes a ground floor and a number of similar looking floors. The similar looking floors could be represented with one picture. By using in the façade library only one picture for all floors, a number of pictures are replaced by a number of references to a picture. This reduces the storage size to store the whole façade. The comparison of pictures can be performed with standard image processing tools and object recognition tools.

The conversion in action 304 could be further improved by splitting a cutout of a façade in components such as windows, doors and specific parameters such as color, texture of wall (brick, wood, chalk, etc). By characterizing a façade by parameters and references to standard window type, door types in a façade component library, the storage capacity for storing a façade can be further reduced. For windows, doors etc, object recognition tools are used to detect standard door types and standard window types, which are stored in the façade component library. The location together with the reference to a picture in the façade component library could be stored as a component of the façade. In another exemplary embodiment the recognized windows and doors of a floor are stored in the façade library in the same order as present in the part of the cutout of the façade. When reproducing said façade, the recognized windows and doors are spread equidistant over the floor. Dummy components could be placed in the sequence of windows and doors to enable, during reproduction of said floor, an apparent un-equidistant spread of the windows and doors over the floor. The dummy components function as a kind of additional space between two detected objects.

Experience has shown that complex shopping streets with typical windows and inscriptions can hardly be converted using windows and door type libraries. Consequently, an image with a full representation of the ground floor of a building with for example a shop will be stored and the other floors of the building will be converted using the window and door type libraries. It has been found that the 3D GDF extension (Geographic Data Files) is suitable to store the façades and roof types as descried above. In co-operation with the Industry (digital map providers, automotive and electronic equipment manufacturers, etc.), the GDF standard was drawn up by the European Committee for Standardisation (CEN) as an exchange format for digital road network data. The outcome of these standardization efforts (CEN GDF 3.0) has formed the major input to the world standard ISO GDF 4.0.

As described above, a building has a footprint with boundaries corresponding to the outer walls of said building. According to the method only one height value is added to a footprint. Consequently, all walls and thus façades of the building have equal height. Furthermore, boundaries of a footprint cannot be in line with each other. Consequently, for each straight outer wall one façade will be generated. To enable the reproduction of a building with different heights, a sub-footprint could be added to the building in the city map, the sub-footprint being associated with a different height than the footprint itself. A sub-footprint defines an area in the area of the footprint and does not have a boundary outside the footprint. By using the method described above, the height of the building corresponding to the sub-footprint could be determined and subsequently the façades corresponding to the boundaries of said sub-footprint. To reduce the storage capacity needed to store façades for said sub-footprint only details of the façades above the height of the footprint have to be stored.

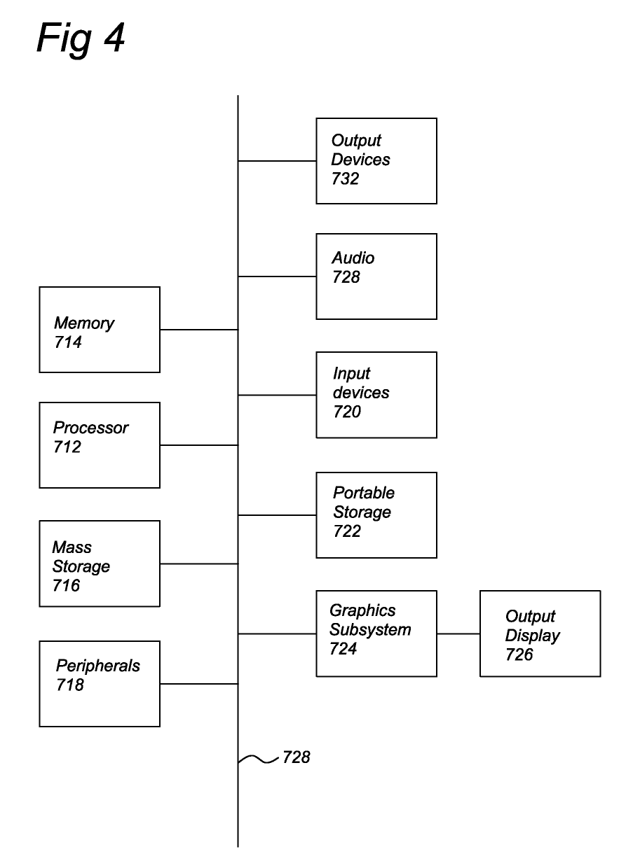

FIG. 4 illustrates a high level block diagram of a computer system which can be used to implement the enhanced map generator and/or a device for reproducing a 3D view of the enhanced map.

The computer system of FIG. 4 includes a processor unit 712 and main memory 714. Processor unit 712 may contain a single microprocessor, or may contain a plurality of microprocessors for configuring the computer system as a multi-processor system. Main memory 714 stores, in part, instructions and data for execution by processor unit 712. If the method of the present invention is wholly or partially implemented in software, main memory 714 stores the executable code when in operation. Main memory 714 may include banks of dynamic random access memory (DRAM) as well as high speed cache memory.

The system of FIG. 4 further includes a mass storage device 716, peripheral device(s) 718, input device(s) 720, portable storage medium drive(s) 722, a graphics subsystem 724 and an output display 726. For purposes of simplicity, the components shown in FIG. 4 are depicted as being connected via a single bus 728. However, the components may be connected through one or more data transport means. For example, processor unit 712 and main memory 714 may be connected via a local microprocessor bus, and the mass storage device 716, peripheral device(s) 718, portable storage medium drive(s) 722, and graphics subsystem 724 may be connected via one or more input/output (I/O) buses. Mass storage device 716, which may be implemented with a magnetic disk drive or an optical disk drive, is a non-volatile storage device for storing data, such as the original 2D city map, geo-coded image sequences and enhanced map, and instructions for use by processor unit 712. In one embodiment, mass storage device 716 stores the system software for implementing the present invention for purposes of loading to main memory 714.

Portable storage medium drive 722 operates in conjunction with a portable non-volatile storage medium, such as a floppy disk, micro drive and flash memory, to input and output data and code to and from the computer system of FIG. 4. In one embodiment, the system software for implementing the present invention is stored on such a portable medium, and is input to the computer system via the portable storage medium drive 722. Peripheral device(s) 718 may include any type of computer support device, such as an input/output (I/O) interface, to add additional functionality to the computer system. For example, peripheral device(s) 718 may include a network interface card for interfacing computer system to a network, a modem, etc.

Input device(s) 720 provide a portion of a user interface. Input device(s) 720 may include an alpha-numeric keypad for inputting alpha-numeric and other key information, or a pointing device, such as a mouse, a trackball, stylus, or cursor direction keys. In order to display textual and graphical information, the computer system of FIG. 14 includes graphics subsystem 724 and output display 726.

Output display 726 may include a cathode ray tube (CRT) display, liquid crystal display (LCD) or other suitable display device. Graphics subsystem 724 receives textual and graphical information, and processes the information for output to display 726. Output display 726 can be used to report the results of a path finding determination, display an enhanced map, display directions, display confirming information and/or display other information that is part of a user interface. The system of FIG. 4 also includes an audio system 728, which includes a microphone. In one embodiment, audio system 728 includes a sound card that receives audio signals from the microphone. Additionally, the system of FIG. 4 includes output devices 732. Examples of suitable output devices include speakers, printers, etc.

The components contained in the computer system of FIG. 4 are those typically found in general purpose computer systems, and are intended to represent a broad category of such computer components that are well known in the art.

Thus, the computer system of FIG. 4 can be a personal computer, workstation, minicomputer, mainframe computer, etc. The computer can also include different bus configurations, networked platforms, multi-processor platforms, etc. Various operating systems can be used including UNIX, Linux, Windows, Macintosh OS, and other suitable operating systems.

Navigation systems are generally dedicated devices based on computer technology. They comprise a lot of the features described above. At least a navigation system comprises an input device, a processor readable storage medium a processor in communication with said input device and said processor readable storage medium and an output device to enable the connection with a display unit.

The method described above could be performed automatically. It might happen that the images are such that image processing tools and object recognition tools need some correction. For example the detection of the transition of the façade and the roof could be difficult. In that case the method includes some verification and manual adaptation actions to enable the possibility to confirm or adapt intermediate results. These actions could also be suitable for accepting intermediate results or the final result of the conversion action 304.

The foregoing detailed description of the invention has been presented for purposes of illustration and description. It is not intended to be exhaustive or to limit the invention to the precise form disclosed, and obviously many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1-19. (canceled)

20. A method for generating an enhanced map, comprising the steps of:
retrieving at least one image sequence which has been obtained while driving on a road network, each image having corresponding location coordinates;
retrieving a set of data of an object from an electronic map, the set of data including location coordinates of the object;
selecting from the at least one image sequence at least one image including a representation of the object by means of the location coordinates of the at least one image and the location coordinates in the set of data;
determining from the selected at least one image at least one characteristic of the object;
adding the at least one characteristic of the object to the set of data; and
storing the set of data and the at least one characteristic in said enhanced map.

21. The method according to claim 20, wherein said selecting includes
selecting from the at least one image sequence at least two images, each of the at least two images including a representation of the object by means of the location coordinates of the at least two images and the location coordinates in the set of data;
and a characteristic of the object is a height of the object.

22. The method according to claim 21, wherein the at least one image sequence includes a stereoscopic image sequence and said selecting includes selecting a stereoscopic image pair so as to obtain the at least two images.

23. The method according to claim 20, the set of data comprising location information of a façade, and a characteristic of an object is a façade, wherein said determining includes
determining in the at least one image the location of the ground floor of said façade corresponding to the object;
determining in the at least one image the location of the transition of said façade and a roof corresponding to the object;
calculating the height of the object by means of the location of the ground floor and the location of the transition.

24. The method according to claim 20, the method further comprising:
transforming the selected image into a frontal view image of a façade of the object by means of the location coordinates of the at least one image and the location coordinates of the object;
generating a cutout corresponding to the frontal view of the façade of said object by means of the location coordinates and a height of the façade;
converting the cutout to a representation of the cutout;
storing the representation of the cutout in said enhanced map.

25. The method according to claim 24, wherein said storing includes:
generating Meta data for said representation of the cutout, the Meta data including location coordinates corresponding to the location coordinates in the set of data;
combining the representation of the cutout and the Meta data;
storing the combination in a library of said enhanced map.

26. The method according to claim 24, wherein said converting action includes:
determining a number of floors in the cutout;
storing the number of floors in said enhanced map.

27. The method according to claim 24, wherein said converting action includes:
splitting up the cutout in components;
comparing the components with façade components stored in a component library;
replacing components with similar façade components in the component library by corresponding references to said similar façade components.

28. The method according to claim 24, wherein the enhanced map is dedicated for a predefined application, and the set of data includes a footprint of a building, the footprint includes elements each representing a façade, each element includes location coordinates, wherein execution of the storing for an element is performed in dependence on the predefined application.

29. An apparatus including a processor readable storage medium storing an enhanced map, said enhanced map having a characteristic of an object added to said enhanced map according to the method of:
retrieving at least one image sequence which has been obtained while driving on a road network, each image having corresponding location coordinates;
retrieving a set of data of an object from an electronic map, the set of data including location coordinates of the object;
selecting from the at least one image sequence at least one image including a representation of the object by means of the location coordinates of the at least one image and the location coordinates in the set of data;
determining from the selected at least one image at least one characteristic of the object;
adding the at least one characteristic of the object to the set of data; and
storing the set of data and the at least one characteristic in said enhanced map.

30. An apparatus for performing the method according to claim 20, the apparatus comprising:
an input device;
a processor readable storage medium; and
a processor in communication with said input device and said processor readable storage medium;
an output device to enable the connection with a display unit;
said processor readable storage medium storing code to program said processor to perform a method comprising the actions of
retrieving at least one image sequence which has been obtained while driving on a road network, each image having corresponding location coordinates;
retrieving a set of data of an object from an electronic map, the set of data including location coordinates of the object;
selecting from the at least one image sequence at least one image, each of the at least one images including a representation of the object by means of the location coordinates of the at least one image and the location coordinates in the set of data;
determining from the selected at least one image a height of the object;
adding the height of the object to the set of data;
storing the set of data and the height in said enhanced map.

31. An apparatus for reproducing a set of data stored in an enhanced map generated by the method according to claim 20, the apparatus comprising:
an input device;
a processor readable storage medium; and
a processor in communication with said input device and said processor readable storage medium;
an output device to enable the connection with a display unit;
said processor readable storage medium storing code to program said processor to perform a method comprising the actions of
reading a set of data of an object from said processor readable storage medium, said set of data including location coordinates and height information of said object, said object representing a building with a roof,
generating a perspective view of the object using the location coordinates and the height information, wherein the height information defines the distance between the ground floor and the transition of the sidewalls and the roof.

32. A method for generating an enhanced map, comprising the steps of:
retrieving at least one image sequence which has been obtained while driving on a road network, each image having corresponding location coordinates;
retrieving a set of data of an object from an electronic map, the set of data including location coordinates of a façade of said object and an object height;
selecting from the at least one image sequence an image by means of the location coordinates of the image sequences and the location coordinates in the set of data, in which said image includes a representation of the object;
transforming the selected image into a frontal view image of a façade of the object by means of the location information;
generating a cutout corresponding to the frontal view of the façade of said object by means of the location coordinates and the height;
converting the cutout in a representation of the cutout; and
storing the representation of the cutout in said enhanced map.

33. A method for generating an enhanced map, comprising the steps of:
retrieving a set of data of an object from an electronic map, the set of data including location coordinates of a façade of said object and an object height;
retrieving a representation corresponding a frontal view image of said façade, generating Meta data for said representation, the Meta data including location coordinates corresponding to the location coordinates in the set of data;
combining the representation and the Meta data; and
storing the combination in a library of said enhanced map.

34. A processor readable storage medium storing an enhanced map, said enhanced map having characteristics of an object added to said map according to the method of:
retrieving at least one image sequence which has been obtained while driving on a road network, each image having corresponding location coordinates;
retrieving a set of data of an object from an electronic map, the set of data including location coordinates of the object;
selecting from the at least one image sequence at least one image including a representation of the object by means of the location coordinates of the at least one image and the location coordinates in the set of data;
determining from the selected at least one image at least one characteristic of the object;
adding the at least one characteristic of the object to the set of data; and
storing the set of data and the at least one characteristic in said enhanced map.

35. The processor readable storage medium according to claim 34, wherein a characteristic of the object is a height of the object.

36. The processor readable storage medium according to claim 34, wherein the enhanced map includes a representation of a façade, wherein the representation of the façade has been obtained by transforming a perspective view image of said façade into a frontal view image of said façade.

37. The processor readable storage medium according to claim 34, wherein the enhanced map includes an electronic map and a façade library, the electronic map includes the set of data of the object, the set of data including location coordinates, the façade library comprising a data structure including a representation of a façade corresponding to the object and location coordinates, the location coordinates in the structure being similar to location coordinates in the set of data.

38. The processor readable storage medium according to claim 34, wherein the enhanced map includes a representation of a façade, the façade including more than one component, one component representing the ground floor of building being a full representation of the façade on the first floor.
